(19) United States
(12) Patent Application Publication
(10) Pub. No.: US 2024/0050998 A1
(43) Pub. Date: Feb. 15, 2024

(54) DE-SCALING DEVICE

(71) Applicant: The Plug Hug, LLC, Bellville, OH (US)

(72) Inventor: Terrence K. Byrne, St. James City, FL (US)

(73) Assignee: The Plug Hug, LLC, Bellville, OH (US)

(21) Appl. No.: 18/084,308

(22) Filed: Dec. 19, 2022

Related U.S. Application Data
(60) Provisional application No. 63/396,815, filed on Aug. 10, 2022.

(51) Int. Cl. B08B 9/087; A46B 13/00; A46B 13/02; A46B 9/02; A46D 1/00

(52) U.S. Cl. CPC B08B 9/087; A46B 13/001; A46B 13/02; A46B 9/026; A46D 1/0207; A46B 2200/3093; A46B 2200/3073; B08B 2209/08

(57) ABSTRACT

A cleaning apparatus for the on-site de-scaling of a stationary object, includes a housing having a plurality of panels detachably mounted to the housing side wall exterior surface so that the panel outer faces are radially oriented in relation to the housing. A plurality of elongated cleaning members, such as bristles or needles, each includes a first end mounted to one of the panels and a second end extending away from the panel outer face. The elongated cleaning members extend radially outwardly from the housing and the elongated cleaning members are adapted to contact a surface of the stationary object to be cleaned and de-scaled.

### CLAIM OF PRIORITY

This application claims priority from U.S. Provisional Patent Application Ser. No. 63/396,815, filed on Aug. 10, 2022, the entirety of which is hereby incorporated by reference.

### BACKGROUND OF THE DISCLOSURE

It would be advantageous to provide a rotary brush cleaning system to clean and remove rust or iron oxide from larger objects such as metal bins or containers, ships, railcars, buildings, etc., with a brush system including bristles that contact or are capable of contacting the exterior surface of the item to be cleaned. The system could be mounted to an excavator or a tractor or other device so that an effective and quick cleaning of the item can take place by a single worker without the need for ancillary equipment such as generators, air compressors, a supply of cleaning material and the like and without needing multiple personnel during the cleaning process. Such a motorized cleaning system would also eliminate the need for multiple workers to be employed in the cleaning process, as a mechanized system would be significantly faster in cleaning the item than would be a manual process for doing so. In other words, it would be advantageous to provide a one-man cleaning system in order to reduce the costs with sanding and de-scaling large objects.

Currently, the methods of large-scale sanding or grinding away rust or iron oxide from large items such as, but not limited to, ships, railcars, metal buildings, overseas containers, etc., include:
Sandblasting;
Chemicals;
Pneumatic or electrical needlers;
Handheld wire whips or grinders; and
Pressure washers.

Describing and understanding the current methods of large-scale removal of iron oxide will make it become easily evident why the de-scaling device of the present disclosure is the superior process for obtaining a “paint ready” surface for large metal areas that have become rusted and unpleasant in appearance over time.

For example, sandblasting is labor intensive, messy, environmentally unfriendly, and causes many hand-eye injuries, and back strains. Sandblasting also requires a great amount of expensive equipment and necessary undesirable clean up.

Chemicals are also environmentally unfriendly and can be dangerous to the user. Cost and clean up are other factors that need to be considered with chemicals. Equipment required for this process is unfavorable, expensive, and user unfriendly.

A problem with handheld wire whips is they quickly cause operator fatigue and are very low on the production rate scale. Many hand-eye injuries are caused by handheld wire wheels.

Pneumatic or electrical needlers fall into the same category as the handheld wire whips and handheld wire wheels. That is, very similar safety hazards, cost, user fatigue and production loss.

Pressure washers are ineffective, messy, and quickly cause operator fatigue, resulting in a more unsafe work environment, waste of precious water resources, and instill an unfriendly disposition on the operator. Extreme high-pressure washers that are effective on the removal of iron oxide are also very costly, i.e., in excess of $100,000.00.

Cleaning applications can include, but are not limited to, shipping vessels, rail cars, shipping containers, factory bins, dumpsters, etc.

Thus, there is a need for a large volume substantive descaling attachment that removes rust, paint, debris, and erosive marine layers (i.e., barnacles, etc.) for the preparation of resurfacing, painting, and coatings of large objects which overcomes the above-mentioned deficiencies and others, while providing better overall results.

### BRIEF DESCRIPTION OF THE DISCLOSURE

The present disclosure relates to de-scaling large objects, such as metal bins or containers, ships, railcars, buildings, etc. More particularly, it relates to a de-scaling device which has bristles which rotate and remove rust and iron oxide from the large objects.

In accordance with one aspect of the present disclosure, a cleaning apparatus, i.e., a large volume mechanical de-scaling device, for cleaning an associated large object preferably has a motor, an output drive shaft powered by the motor and a cleaning attachment coupled for rotational movement with the output drive shaft and having an axis of rotation. The cleaning attachment comprises a housing including an outer surface and a plurality of elongated cleaning members mounted to the outer surface of the housing.

In accordance with another aspect of the present disclosure, provided is a cleaning apparatus for the on-site cleaning, sanding or de-scaling of a large stationary object. The cleaning apparatus includes a housing, including an exterior surface. A plurality of elongated cleaning members is mounted to the housing exterior surface. A motor is provided for rotating the housing along a generally vertical axis in relation to the associated stationary object.

In accordance with still another aspect of the present disclosure, provided is a method for cleaning a stationary object. The method includes providing a housing equipped with elongated cleaning members located on an exterior surface thereof. The housing is positioned adjacent the stationary object. Thereafter, the housing is rotated and an exposed surface of the stationary object is contacted with the elongated cleaning members to sand or de-scale the object.

In accordance with another aspect of the disclosure, a cleaning apparatus for the on-site cleaning of an associated stationary object includes a housing including a top wall, a bottom wall, and a side wall; a plate being detachably mounted to the housing side wall exterior surface so that the plate outer face is outwardly oriented in relation to the housing; at least one elongated cleaning member including a first end mounted to the plate and a second end extending away from the plate; a fastener adapted to connect the plate to the exterior surface of the housing. The at least one elongated cleaning member extends radially outwardly from the housing and is adapted to contact a surface of the associated stationary object and remove rust and iron oxide.

In accordance with another aspect of the disclosure, a detachable cleaning element is used in an associated cleaning apparatus for the on-site cleaning of an associated stationary object, the cleaning element includes: a plate; a plurality of elongated cleaning members each including a first end mounted to the plate and a second end extending away from the plate; and the plate is selectively secured to an exterior side wall of a housing of the associated cleaning apparatus such that the elongated cleaning members protrude away from the housing of the associated cleaning apparatus.

Another aspect of the disclosure is it provides a “one trip, one touch” process.

Another aspect of the disclosure is it provides a “safety zone” for hands off operations which eliminates hand, eye, and back injuries.

Still another aspect of the disclosure is it provides effective SSPC results for a prepared surface for new paint application and coatings. For example, a six-foot square area can be “paint ready” in under ten seconds.

Another aspect of the disclosure is that the de-scaling device is one of the world's biggest large volume mechanical de-scaling units.

Still another aspect of the disclosure is thousands of individual de-scaling needles make up the outside skin of the de-scaling device that result in a most aggressive, expedient, safe and very cost-efficient procedure for large de-scaling jobs, such as ships, railcars, overseas containers, and any other mass structures of steel that have iron oxide buildup and corrosion over an extended period of time.

Another aspect of the disclosure is the de-scaling device is a safer method than existing methods because the single operator is located a considerable distance away from the point of contact of the de-scaling process, plus the operator is seated in an enclosed protective area. In addition, with using the de-scaling device, there is no manual labor involved such as lifting sandbags for sandblasting, mixing dangerous chemicals, fatigue ridden handheld grinders and pneumatic needlers, back-breaking pressure washing with massive amounts of prep and clean up.

Still other aspects of the present disclosure will become apparent upon a reading and understanding of the following detailed description.

### BRIEF DESCRIPTION OF THE DRAWINGS

FIG. 1 is a perspective view of an existing gravel bin to be de-scaled.

FIG. 2 is a perspective view of a de-scaling device mounted to an excavator according to a preferred embodiment of the disclosure.

FIG. 3 is a perspective view of the de-scaling device of the present disclosure.

FIG. 4 is a top plan view of the de-scaling device of FIG. 3.

FIG. 5 is a side elevational view of the de-scaling device of FIG. 3.

FIG. 6 is another side elevational view of the de-scaling device of FIG. 3.

FIG. 7 is a perspective view of a housing for a de-scaling device according to a preferred embodiment of the disclosure.

FIG. 8 is a perspective view of a portion of an exterior of the housing.

FIG. 9 is an enlarged side elevational view of a plurality of cleaning members in accordance with a preferred embodiment of the disclosure.

### DETAILED DESCRIPTION OF THE DISCLOSURE

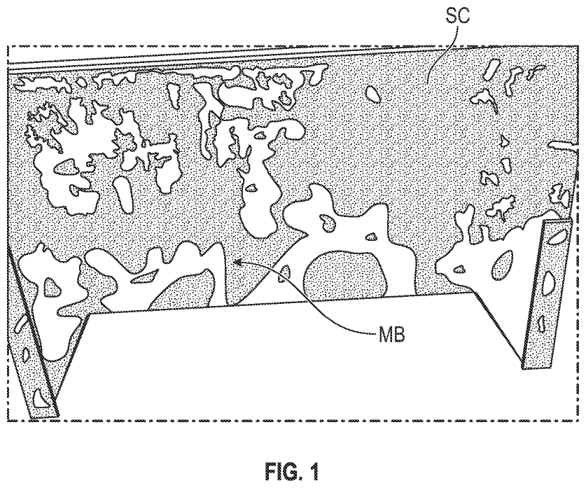

With reference now to FIG. 1, a gravel metal bin or dumpster MB which has a large amount of rust and scale SC to be cleaned by sanding or de-scaling is shown. As can be seen in FIG. 1, a large amount of rust and iron oxide forms on the outer walls of the bin MB over an extended period of time, particularly since it is stored outdoors. The disclosure is used to remove rust and scale from a bin, such as MB. The rust and scale is unsightly and has to be removed so the bin can be primed and painted.

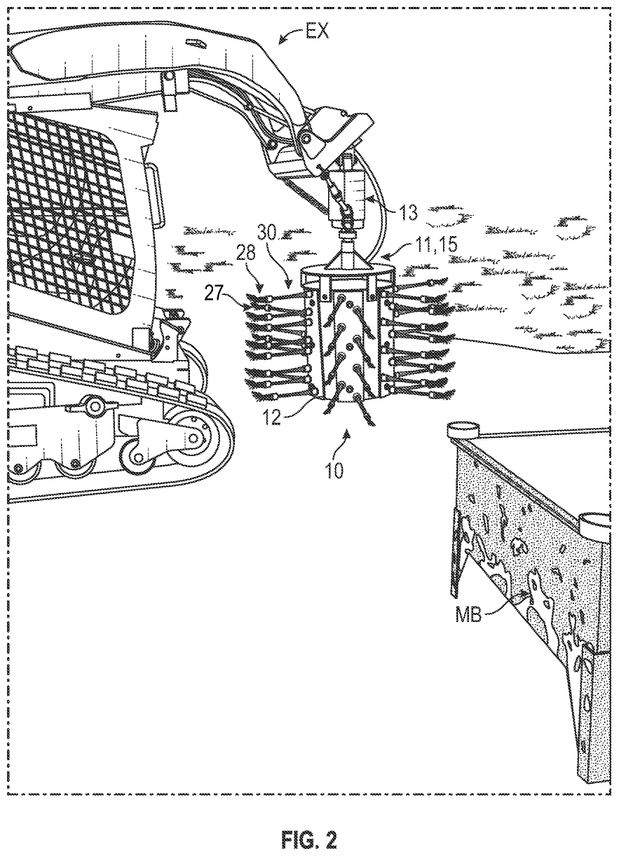

Referring now to FIGS. 2-9, a preferred embodiment of the present disclosure is shown. The embodiment is directed to a de-scaling device 10 which will remove the rust, iron oxide and scale build-up SC and other debris from the metal bin MB, as well as other large objects as previously described.

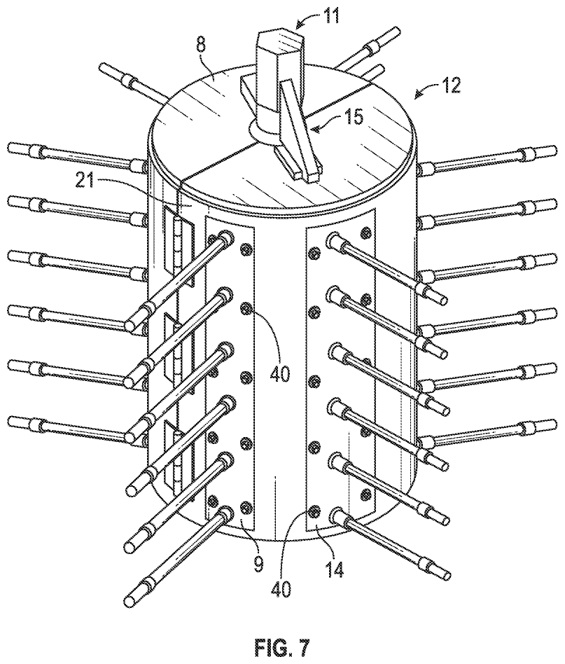

The de-scaling device 10 includes a large volume iron oxide de-scaling attachment housing 12 which is preferably manufactured using a 24-inch diameter steel casing with a ⅜-inch wall. Housing 12 may also be formed by two clam-shell members 8, 9 secured together, such as shown in FIG. 7.

Referring to FIG. 2, the de-scaling device 10 is preferably driven and rotated by a standard post hole hydraulic motor 13 using a two-inch hexagon female coupler. The device preferably has an arbor attachment 11 mounted via arbor gussets 15. The arbor attachment is configured to connect to motor 13 for rotating the device with respect to the object being cleaned. The motor 13 in turn is attached to an excavator EX or other machinery for moving the de-scaling device around and raising and lowering the de-scaling device.

In one embodiment, the de-scaling device preferably connects to a standard hydraulic auger drive motor 13 attached to a skid steer, backhoe, or excavator EX for a turn-key operational platform.

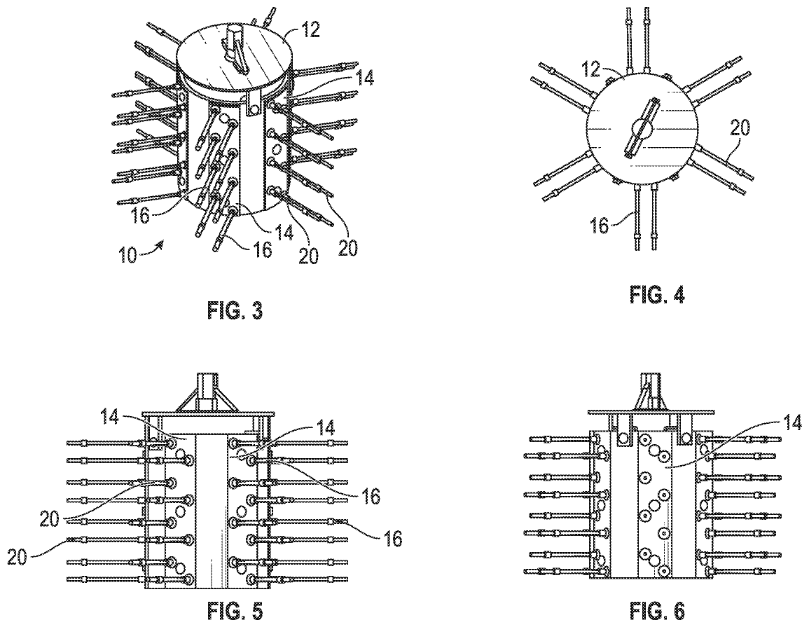

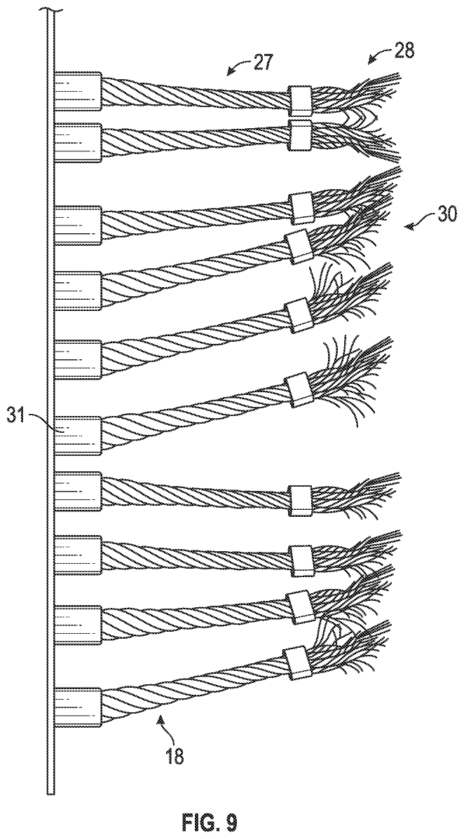

Referring now to FIGS. 3-6, bolted directly to this heavy-duty housing 12 are six de-scaling panels 14. Three of the cable assembly plates or panels 14 may have rods or pipes 16 which extend radially outwardly and can be offset and parallel to each other. The rods or pipes 16 can have one inch steel cables 18 (FIG. 9) crimped around them or otherwise secured to them. The cable assemblies 18 are welded or otherwise fastened to plates 14. Alternatively, cable 18 can be crimped or otherwise secured directly to plate 14. Plates 14 in turn are bolted or otherwise removably secured to the cylindrical housing 12.

Plates or panels 14 may have rods 20 which also extend radially outward and can be offset and parallel to each other. The rods 20 may have ¾-inch cable 18 crimped or wrapped around them. Alternatively, the cables 18 can be crimped or otherwise secured directly to plates 14 (FIG. 2). The six plates or panels 14 are strategically balanced for smooth operation even during the most demanding applications.

Three of the panels 14 have 16.5 inches long by 1-inch-thick steel cables, while three other panels have cables that are 16.5 inches long by ¾ inches in thickness. Each of the panels are easily replaceable for quick and easy maintenance.

Referring to FIG. 9, the six panels 14 of the de-scaling device contain cleaning members 27 which can have cables 18 and over 8,000 individual needles 28, 30, consequently providing the end user with a highly efficient record-breaking production result. The de-scaling device is rotated at a high speed by motor 13 resulting in the bristles or needles 28, 30 scrubbing and removing the rust and iron oxide deposits of the bin MB from the surface.

Each of these panels supports a plurality of elongated cleaning members 27. In one embodiment, the elongated cleaning members comprise bristles 28, 30 made of a suitable material such as metal wire or the like. In another embodiment, the elongated cleaning members may comprise descaling needles. Such needles are known in the art and generally range in diameter from 2 mm to 4 or 5 mm and in some embodiments will have a length of 180 mm or more. Some descaling needles have a flat tip, while others are chisel tipped. The use of such needles for removing foreign substances from metal, wood, stone or the like is known. The needles are typically formed of drill rod or similar tough hard elastic steel. Descaling needles are known for removing scale from welds and for removing foreign substances from generally rigid surfaces. Normally, descaling needles are used in a reciprocating manner being propelled either pneumatically or with a reciprocating hammer.

The present disclosure pertains to the use of such elongated cleaning members, whether they be termed descaling needles or metal brush elements or the like in one or more plates or panels 14, or otherwise rigidly attached to an exterior surface of the housing 12 so as to selectively contact the exposed surfaces of a stationary object which is to be cleaned by the apparatus disclosed herein. In one embodiment, brush elements, made of a spring steel wire, are provided in a single length but with two different diameters. More particularly, the cleaning members 27 can be 11 inches (27.94 cm) in length and can come in a larger diameter of 0.177 inches (0.45 cm) and a smaller diameter of 0.090 inches (0.23 cm).

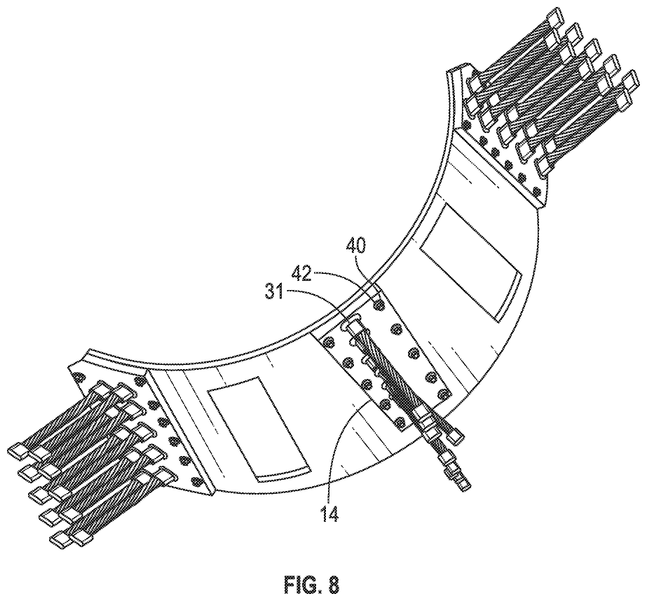

Referring to FIG. 8, fasteners 40 extend through apertures 42 in the panels and the housing in order to selectively connect the panels 14 to the housing 12.

With reference now to FIG. 7, a panel 14 is selectively secured to an exterior surface 21 of the housing 12. In particular embodiments, the panels 14 can be generally rectangular in configuration. The panels 14 may be selectively secured to the housing 12 by any suitable means, such as fasteners 40. It should be appreciated that the panels 14 are removably mounted to the housing 12, so that the panels 14 can be removed and replaced when at least some of the cleaning members 27 are no longer effective for their cleaning function.

With continued reference to FIG. 8, it can be seen that some of the panels 14 can be wider so that they can accommodate two generally vertically aligned sets of cleaning members 27 if needed, whereas other panels 14 can only accommodate a single set of cleaning members 27. The distal ends of each respective cleaning member 27 can be held in respective collars 31 which can be secured to the panels 14 by conventional means, such as weld joints.

In the embodiment shown in FIGS. 8 and 9, the cables 18 each include a respective collar 31 mounted to a distal end of each of the elongated cables 18. The purpose of providing the elongated cables 18 with collared ends is to provide added strength to the elongated cables 18 when clearing dirt, scale or other heavy debris from around the stationary object.

The ends of the cable form elongated cleaning members 27 such as needles or bristles 28, 30 for cleaning or de-scaling the object. The bristles can be formed of metal wire or the like. As can be seen in FIG. 2, the bristles 28, 30 can extend not only radially, but also axially to aid in thoroughly cleaning the object surface. In this way, when the motor 13 rotates the housing 12, the bristles will contact and clean all of the exterior surfaces of the object. Plates 14 along with the bristles can be easily removed and replaced onto the cylinder when the bristles can no longer properly function to perform cleaning. When needed, the de-scaling device's needles 28, 30 can be easily and quickly replaced therefore eliminating costly down time.

The de-scaling device produces results that are compliant with Substrate Cleaning Standards SSPC-SP2, SSPC-SP3, SSPC-SP11, and SSPC-SP15.

The de-scaling device 10 can preferably be made as a steel canister with dimensions such as 24 inches in diameter, 26 inches high and ⅜ inches thick with six external panels.

The de-scaling device 10 is preferably strategically balanced for smooth operation in demanding environments.

The disclosure has been described with reference to several embodiments. Obviously, modifications and alterations will occur to others upon a reading and understanding of this specification. It is intended to include all such modifications and alterations in so far as they come within the scope of the description and the appended claims or the equivalents thereof.

1. A cleaning apparatus for the on-site cleaning and de-scaling of an associated stationary object, comprising:
a housing including a top wall, a bottom wall, and a side wall;
an attachment member depending from the top wall;
a panel including an outer face, the panel being detachably mounted to said housing side wall exterior surface so that the panel outer face is radially oriented in relation to the housing;
at least one elongated cleaning member including a first end mounted to the panel and a second end extending away from the panel outer face;
wherein the at least one elongated cleaning member extends radially outwardly from the housing, the elongated cleaning member being adapted to contact a surface of the associated stationary object to clean said surface of the associated object.

2. The apparatus of claim 1, wherein said at least one elongated cleaning member further comprising a plurality of elongated cleaning members spaced from each other, wherein each of said plurality of elongated cleaning members is mounted at a first end to said panel.

3. The apparatus of claim 1, wherein the at least one elongated cleaning member comprises a metal wire.

4. The apparatus of claim 1, wherein the housing is generally cylindrical.

5. The apparatus of claim 1, wherein said at least one elongated cleaning member comprises a plurality of bristles.

6. A detachable cleaning element used for the on-site cleaning of an associated stationary object, the cleaning element comprising:
a housing having a plurality of panels;
a plurality of elongated cleaning members each including a first end mounted to one of said plurality of panels and a second end extending away from said one of said plurality of panels; and
wherein said plurality of panels are adapted to be selectively secured to an exterior side wall of a housing of the cleaning element such that the elongated cleaning members protrude radially away from the housing of the cleaning element.

7. The element of claim 6, wherein the plurality of elongated cleaning members extend generally parallel to each other and are spaced from each other.

8. The element of claim 6, wherein the plurality of panels are each generally rectangular in shape.

9. The element of claim 6, wherein said plurality of panels, spaced from each other, are each selectively secured to the exterior side wall of the cleaning element.

10. The element of claim 6, wherein each of said plurality of panels comprises at least one aperture and further comprising a fastener adapted to extend through the at least one aperture and connect each of said plurality of panels to the exterior side wall of the associated housing.

11. The element of claim 6, wherein the at least one elongated cleaning member comprises a metal wire.

12. The element of claim 6, wherein the housing is generally cylindrical.

13. The element of claim 6, wherein said at least one elongated cleaning member comprises a plurality of bristles.
